(19) United States
(12) Patent Application Publication
(10) Pub. No.: US 2020/0311492 A1
(43) Pub. Date: Oct. 1, 2020

(54) OBJECT DETECTOR HAVING SHALLOW NEURAL NETWORKS

(71) Applicant: Cortica Ltd

(72) Inventors: Igal Raichelgauz, Tel Aviv (IL); Roi Saida, Acco (IL)

(21) Appl. No.: 16/681,863

(22) Filed: Nov. 13, 2019

Related U.S. Application Data
(60) Provisional application No. 62/827,112, filed on Mar. 31, 2019.
(60) Provisional application No. 62/827,126, filed on Mar. 31, 2019.

(51) Int. Cl. G06K 9/68; G06K 9/32; G06K 9/36; G06N 3/04; G06N 3/08

(52) U.S. Cl. CPC G06K 9/6857; G06K 9/3233; G06N 3/08; G06N 3/0454; G06K 9/36

(57) ABSTRACT

A method that may include receiving or generating multiple versions of an input image, wherein the multiple versions differ from each other by resolution; feeding the multiple versions of the input image to multiple branches of an object detector; wherein the multiple branches comprise multiple shallow neural networks that are followed by multiple region units; calculating, by the multiple branches, candidate bounding boxes that are indicative of candidate objects that appear in the multiple versions of the input image; wherein the calculating comprises feeding intermediate results from shallow neural networks of lower resolution branches to shallow neural networks of higher resolution branches; and selecting bounding boxes out of the candidate bounding boxes, by a selection unit that follows the multiple branches

### CROSS REFERENCE

This application claims priority from US provisional patent 62/827,126 filing date Mar. 31, 2019.

### BACKGROUND

Object detection is required in various systems and applications.

There is a growing need to provide a method and a system that may be able to provide highly accurate object detection at a low cost.

### SUMMARY

There may be provided a method for object detection, the method may include receiving or generating multiple versions of an input image, wherein the multiple versions differ from each other by resolution; feeding the multiple versions of the input image to multiple branches of an object detector; wherein the multiple branches may include multiple shallow neural networks that may be followed by multiple region units; wherein each branch may include a shallow neural network and a region unit; calculating, by the multiple branches, candidate bounding boxes that may be indicative of candidate objects that appear in the multiple versions of the input image; wherein the calculating may include feeding intermediate results from shallow neural networks of lower resolution branches to shallow neural networks of higher resolution branches; and selecting bounding boxes out of the candidate bounding boxes, by a selection unit that follows the multiple branches.

The feeding of the intermediate results may include feeding by each source branch of at least some branches, a target branch that has a next higher resolution than the branch.

The method may include receiving by each target branch, intermediate results from a source branch of a coarser resolution; combining the intermediate results within an output of an intermediate convolutional layer of the target branch to provide combined results; and processing the combined result by one or more additional layers of the target branch.

The combining may include concatenating.

Each source branch may include an adaptor for adapting an intermediate result of the shallow neural network of the source branch before feeding the intermediate result to a shallow neural network of the target branch.

The multiple shallow neural networks may be multiple instances of a trained shallow neural network.

A shallow neural network of a target branch and a shallow neural network of a source branch that feeds the target branch may be trained to detect objects having a size that may be within a predefined size range, and may be trained to ignore objects having a size that may be outside the predefined size range.

The intermediate results may be provided from layers of a first part of the shallow neural network of the source branch; and wherein layers of a first part of the shallow neural network of the target branch and layers of the first part of the shallow neural network of the source branch have a same configuration.

The predefined size range may range between (a) about ten by ten pixels, till (b) about one hundred by one hundred pixels.

The method may include training a shallow neural network of a target branch and a shallow neural network of a source branch that feeds the target branch to detect objects having a size that may be within a predefined size range, and may be trained to ignore objects having a size that may be outside the predefined size range.

There may be provided a non-transitory computer readable medium for detecting an object by an object detector, wherein the non-transitory computer readable medium may store instructions for receiving or generating multiple versions of an input image, wherein the multiple versions differ from each other by resolution; feeding the multiple versions of the input image to multiple branches of an object detector; wherein the multiple branches may include multiple shallow neural networks that may be followed by multiple region units; wherein each branch may include a shallow neural network and a region unit; calculating, by the multiple branches, candidate bounding boxes that may be indicative of candidate objects that appear in the multiple versions of the input image; wherein the calculating may include feeding intermediate results from shallow neural networks of lower resolution branches to shallow neural networks of higher resolution branches; and selecting bounding boxes out of the candidate bounding boxes, by a selection unit that follows the multiple branches.

The feeding of the intermediate results may include feeding by each source branch of at least some branches, a target branch that has a next higher resolution than the branch.

The non-transitory computer readable medium that may store instructions for receiving by each target branch, intermediate results from a source branch of a coarser resolution; combining the intermediate results within an output of an intermediate convolutional layer of the target branch to provide combined results; and processing the combined result by one or more additional layers of the target branch.

The combining may include concatenating.

Each source branch may include an adaptor for adapting an intermediate result of the shallow neural network of the source branch before feeding the intermediate result to a shallow neural network of the target branch.

The multiple shallow neural networks may be multiple instances of a trained shallow neural network.

A shallow neural network of a target branch and a shallow neural network of a source branch that feeds the target branch may be trained to detect objects having a size that may be within a predefined size range, and may be trained to ignore objects having a size that may be outside the predefined size range.

The intermediate results may be provided from layers of a first part of the shallow neural network of the source branch; and wherein layers of a first part of the shallow neural network of the target branch and layers of the first part of the shallow neural network of the source branch have a same configuration.

The predefined size range may range between (a) about ten by ten pixels, till (b) about one hundred by one hundred pixels.

The non-transitory computer readable medium that may store instructions for training a shallow neural network of a target branch and a shallow neural network of a source branch that feeds the target branch to detect objects having a size that may be within a predefined size range, and may be trained to ignore objects having a size that may be outside the predefined size range.

There may be provided an object detector that may include an input unit, multiple branches, and a selection unit; wherein the input unit may be configured to receive or generate multiple versions of an input image, wherein the multiple versions differ from each other by resolution; wherein the multiple branches of the object detector may be configured to (i) receive the multiple versions of the input image to multiple branches of an object detector; wherein the multiple branches may include multiple shallow neural networks that may be followed by multiple region units; wherein each branch may include a shallow neural network and a region unit; (ii) calculate candidate bounding boxes that may be indicative of candidate objects that appear in the multiple versions of the input image; wherein the calculating may include feeding intermediate results from shallow neural networks of lower resolution branches to shallow neural networks of higher resolution branches; and wherein the selection unit may be configured to select bounding boxes out of the candidate bounding boxes, by a selection unit that follows the multiple branches.

Each source branch of at least some branches, may be configured to feed with intermediate results, a target branch that has a next higher resolution than the branch.

Each target branch may include an combiner that may be configured to combine the intermediate results with an output of an intermediate convolutional layer of the target branch to provide combined results; and wherein a shallow neural network of the target branch may include one or more additional layers that the configured to process the combined result.

The combiner may be configured to concatenate the intermediate results with the output of the intermediate convolutional layer of the target branch.

Each source branch may include an adaptor for adapting an intermediate result of the shallow neural network of the source branch before feeding the intermediate result to a shallow neural network of the target branch.

The multiple shallow neural networks may be multiple instances of a trained shallow neural network.

A shallow neural network of a target branch and a shallow neural network of a source branch that feeds the target branch may be trained to detect objects having a size that may be within a predefined size range, and may be trained to ignore objects having a size that may be outside the predefined size range.

The intermediate results may be provided from layers of a first part of the shallow neural network of the source branch; and wherein layers of a first part of the shallow neural network of the target branch and layers of the first part of the shallow neural network of the source branch have a same configuration.

The predefined size range may range between (a) about ten by ten pixels, till (b) about one hundred by one hundred pixels.

### BRIEF DESCRIPTION OF THE DRAWINGS

The embodiments of the disclosure will be understood and appreciated more fully from the following detailed description, taken in conjunction with the drawings in which:

FIG. 1 illustrates an example of an input image of a first resolution and bounding boxes;

FIG. 2 illustrates an example of first and second lower resolution versions of the input image and of bounding boxes;

FIG. 3 illustrates an example of an object detector;

FIG. 4 illustrates an example of a parts of a target branch and of parts of a source branch that belong to the object detector of FIG. 3;

FIG. 5 illustrates an example of four branches of the object detector of FIG. 3;

FIG. 6 illustrates an image and bounding boxes;

FIG. 7 illustrates various objects;

FIG. 8 illustrates an example of a training process; and

FIG. 9 illustrates an example of a method for object detection.

### DESCRIPTION OF EXAMPLE EMBODIMENTS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a device or system capable of executing the method and/or to a non-transitory computer readable medium that stores instructions for executing the method.

Any reference in the specification to a system or device should be applied mutatis mutandis to a method that may be executed by the system, and/or may be applied mutatis mutandis to non-transitory computer readable medium that stores instructions executable by the system.

Any reference in the specification to a non-transitory computer readable medium should be applied mutatis mutandis to a device or system capable of executing instructions stored in the non-transitory computer readable medium and/or may be applied mutatis mutandis to a method for executing the instructions.

Any combination of any module or unit listed in any of the figures, any part of the specification and/or any claims may be provided.

There may be provided a low power object detector, non-transitory computer readable medium and method. The object detector, non-transitory computer readable medium and method are highly efficient as they feed information (such as intermediate results from some layers of a shallow neural network) from different branches (rather shallow neural networks of different branches) that differ from each other by resolution. The different branches are associated with different resolutions are they are fed by different versions of an input image—whereas the different versions differ by resolution.

The feeding of information may reduce redundancy between different branches that may detect the same object.

The reduction in the redundancy may reduce the power consumption, may reduce the number of required computational operations for completing the object detection and may be performed while using fewer computational resources. Tests have shown that a power saving of about 30% may be saved by the suggested scheme.

Furthermore—during a training process a pair of a source branch and a target branch may be trained to that the source branch allocates more resources for detecting (or is more tuned to) objects that are larger (in the input image) than the objects for which the target source is tuned to (or allocated more resource for).

In the suggested object detector the number of filters (used for detecting objects) of a target branch may be reduced due to the information received from a source branch.

This reduction, especially at the beginning of the network contributes to the reduction in computational efforts (for example a reduction in the floating point operation per second).

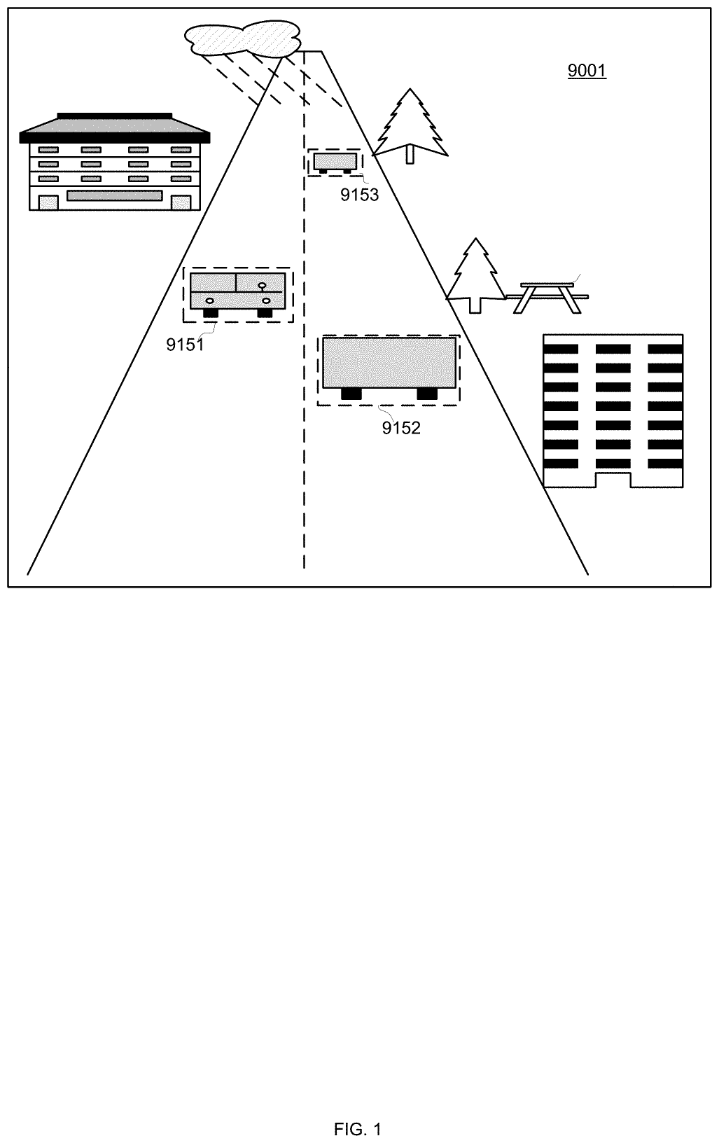

FIG. 1 illustrate an example of an input image 9001 of a first resolution and bounding boxes 9151, 9152 and 9153 that surround three vehicles.

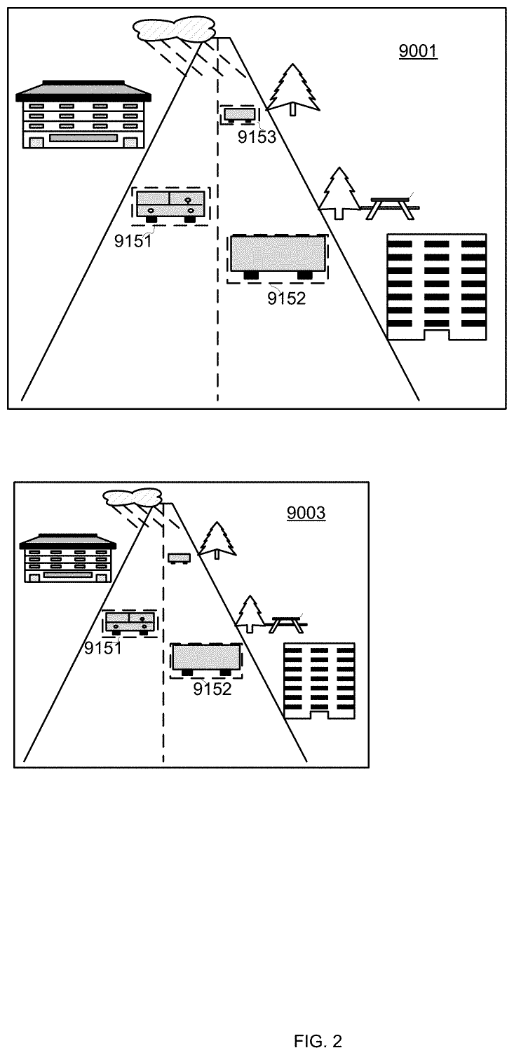

FIG. 2 illustrates a first lower resolution version 9002 of the input image 9001. The first lower resolution version 9002 has a coarser resolution than the input image.

In FIG. 2 an object detector was still able to generate the bounding boxes 9151, 9152 and 9153 that surround the same three vehicles.

FIG. 2 also illustrates a second lower resolution version 9003 of the input image 9001. The second lower resolution version 9003 has a coarser resolution than the first lower resolution version 9002.

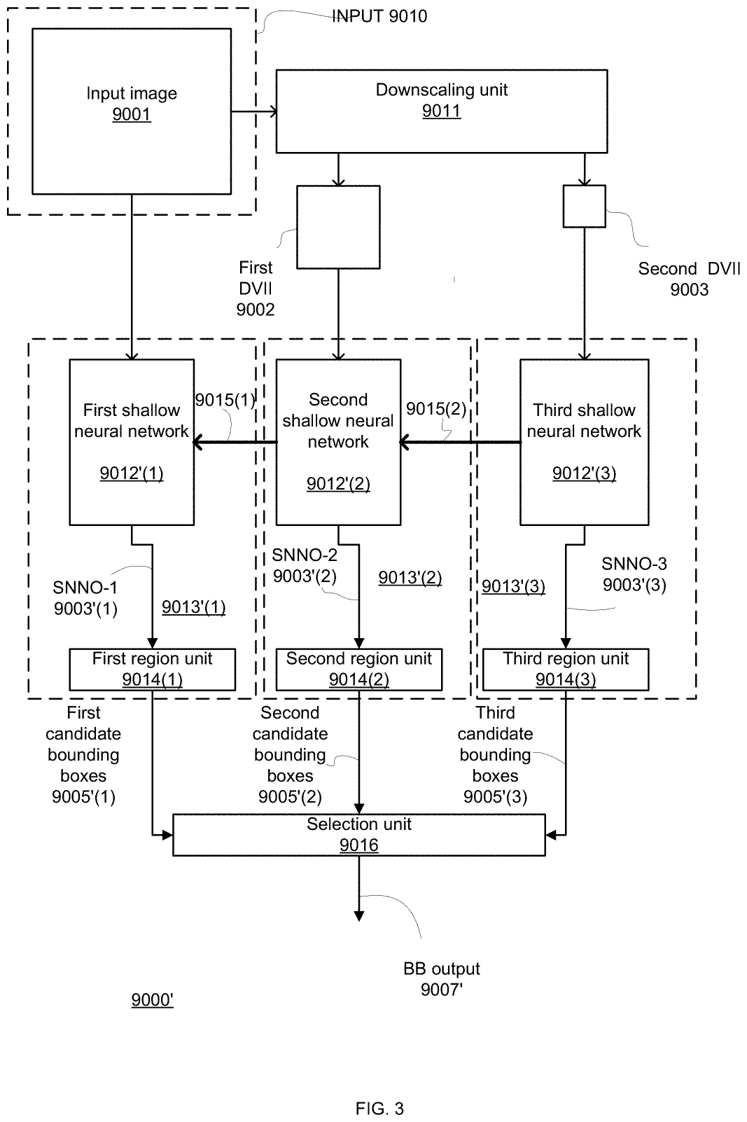

In FIG. 3 an object detector was able to generate only two bounding boxes 9151 and 9152—as the truck that was previously bounded by bounding box 9153 was too small to detect.

FIGS. 1 and 2 illustrate a redundancy between the object detection process applied to the different versions (9001, 9002 and 9003) of the input image—as two vehicles (bounded by bounding boxes 9151 and 9152) were detected in all three versions of the input image.

FIG. 3 illustrates an object detector 9000″ that includes an input 9010 (illustrated as receiving input image 9001), a downscaling unit 9011, multiple branches (such as three branches 9013′(1), 9013′(2) and 9013′(3)), and a selection unit 9016 such as a non-maximal suppression unit.

An input unit that includes input 9010 and downscaling unit 9011 is configured to receive an input image and generate at least one downscaled version of the input image.

First branch 9013′ (1) of of the highest resolution (receives the input image) and is a target branch to second branch 9013′(2).

Second branch 9013′(2) is of medium resolution and feeds (via link 9015(1)) the first branch 9013′(1) with intermediate information regarding the first DVII that is processed by the second branch 9013′.

Third branch 9013′(3) is of low resolution and feeds feeds (via link 9015(2)) the second branch 9013′(2) with intermediate information regarding the second DVII that is processed by the third branch 9013′.

The multiple branches 9013′(1), 9013′(2) and 9013′(3) may be configured to receive the input image and the at least one downscaled version of the input image, one image per branch.

Input image 9001 is fed to first branch 9013′(1) that is configured to calculate first candidate bounding boxes that may be indicative of candidate objects that appear in the input image.

First downscaled version of the input image (DVII) 9002 is fed to second branch 9013′(2) that is configured to calculate second candidate bounding boxes that may be indicative of candidate objects that appear in first DVII 9002.

Second DVII 9003′ is fed to third branch 9013′(3) that is configured to calculate third candidate bounding boxes that may be indicative of candidate objects that appear in second DVII 9003′.

The multiple branches may include multiple shallow neural networks that may be followed by multiple region units.

In first branch 9013′(1), a first shallow neural network 9012′(1) is followed by first region unit 9014(1).

The first shallow neural network 9012′(1) outputs a first shallow neural network output (SNNO-1) 9003′(1) that may be a tensor with multiple features per segment of the input image. The first region unit 9014(1) is configured to receive SNNO-1 9003′(1) and calculate and output first candidate bounding boxes 9005′(1).

The second shallow neural network 9012′(2) outputs a second SNNO (SNNO-2) 9003′(2) that may be a tensor with multiple features per segment of the first DVII 9002. The second region unit 9014(2) is configured to receive SNNO-2 9003′(2) and calculate and output second candidate bounding boxes 9005′(2).

The third shallow neural network 9012′(3) outputs a third SNNO (SNNO-3) 9003′(3) that may be a tensor with multiple features per segment of the second DVII 9003′. The third region unit 9014(3) is configured to receive SNNO-3 9003′(3) and calculate and output third candidate bounding boxes 9005′(3).

The multiple shallow neural networks 9012′(1), 9012′(2) and 9012′(3) may be multiple instances of a single trained shallow neural network.

The single trained shallow neural network may be trained to detect objects having a size that may be within a predefined size range and to ignore objects having a size that may be outside the predefined size range.

The selection unit 9016 may be configured to select bounding boxes (denoted BB output 9007) out of the first, second and third candidate bounding boxes.

The selected bounding boxes may be further processed to detect the objects. Additionally or alternatively—the bounding boxes may provide the output of the object detector.

The branch that receives the input image is configured to detect objects that have a size that is within the predefined size range.

The predefined size range may span along certain fractions of the input image (for example—between less than a percent to less than ten percent of the input image—although other fractions may be selected).

The predefined size range may be tailored to the expected size of images within a certain distance range from the sensor.

The predefined size range may span along certain numbers of pixels—for example between (a) about 10, 20, 30, 40, 50, 60, 70, 80, and 90 pixels by about 10, 20, 30, 40, 50, 60, 70, 80, and 90, and (b) about 100, 110, 120, 130, 140, 150, 160 pixels by about 100, 110, 120, 130, 140, 150, 160 pixels.

Each branch that receives a downscaled version of the input image (assuming of a certain downscaling factor) may detect objects have a size (within the downscaled version of the input image) that is within the predefined size range—and thus may detect images that appear in the input image having a size that is within a size range that equals the predefined range multiplied by the downscaling factor.

Assuming, for example that the input image is of 576×768 pixels (each pixel is represented by three colors), the first DVII is 288×384 pixels (each pixel is represented by three colors), and the second DVII is 144×192 pixels (each pixel is represented by three colors), that SNNO-1 has 85 features per each segment out 36×48 segments, that SNNO-2 has 85 features per each segment out 18×24 segments, that SNNO-3 has 85 features per each segment out 9×12 segments.

The assumption above as well as the example below are merely non-limiting examples of various values. Other values may be provided.

Under these assumptions, each shallow neural network may detect an object having a size between 20×20 to 100×100 pixels and physical receptive field around 200×200 pixels. This assumes automotive objects can be effectively represented using bounding box dimension below 100×100.

In contrast to a single model trained end to end, the following architecture contains several identical shallow neural networks.

The first branch detects small object (as appearing in the input image), the second branch detects medium objects (as appearing in the input image), and the third branch detects large objects (as appearing in the input image)—all may be within a limited predefined size range.

The number of branches, scales, and the downscale factor may differ from those illustrated in FIG. 1. For example—there may be two or more than three branches, the downscaling factor may differ from 2×2, downscaling factors between different images may differ from each other, and the like.

FIG. 3 illustrates an example of a parts of a first branch 9012′(1) that is a target branch, and of parts of second branch 9012′(2) that is a source branch.

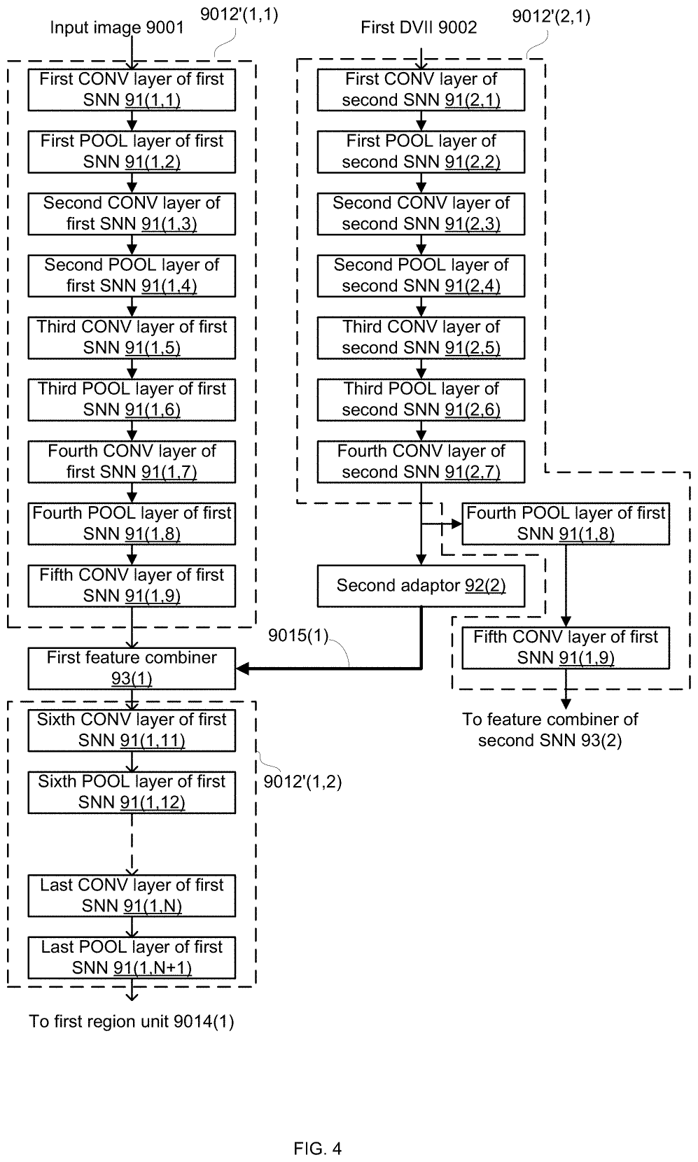

First part 9012′(1,1) of first branch includes alternating convolution (preferably convolution and nonlinearity) and pooling (sampling) layers. For example—FIG. 4 illustrates first, second, third, fourth and fifth convolutional (CONV) layers 91(1,1), 91(1,3), 91(1,5), 91(1,7) and 91(1,9) as well as first, second, third and fourth pooling (POOL) layers 91(1,2), 91(1,4), 91(1,6) and 91(1,8).

The output of the fifth convolutional layer is the output of first part 9012′(1,1) of first branch. This output is fed to first feature combiner 93(1).

The first feature combiner 93(1) also receives intermediate results from first part 9012′(2,1) of second branch 9012′(2).

The intermediate results and the output of the first part 9012′(1,1) of the first branch should be of the same dimensions (same number of segments and same depth).

Because the first part 9012′(2,1) of second branch 9012′(2) receives a downscaled version of the input image received by the first part 9012′(1,1) of first branch—the intermediate results are provided after the fourth convolutional layer of the first part 9012′(2,1) of second branch 9012′(2)—and not after the fifth convolutional layer.

The intermediate results are adapted (before being fed over link 9015(1) to the first feature combiner 93(1)) by a second adaptor 92(2) of the second branch.

The first features combiner 93(1) is configured to combine the intermediate results with an output of an intermediate convolutional layer of the target branch to provide combined results.

The combined results are fed to a second part 9012′(1,2) of first branch 9012′(1) that includes one or more additional layers (of the second part) that are configured to process the combined result.

A non-limiting numerical example of the dimensions of the input image, the first DVII and the dimensions of tensors inputted and outputted from the layers of the first parts of the first and second branches is provided below:
Input image 608×608×3 (608 by 608 pixels, each pixel represented by three colors).
First CONV layer of first part—receives 608×608×3 outputs 304×304×32
Second CONV layer of first part—receives 304×304×32 outputs 152×152×64
Third CONV layer of first part—receives 76×76×128 outputs 38×38×128
Fourth CONV layer of first part—receives 38×38×256 outputs 19×19×512
Fifth CONY layer of first part—receives 19×19×512 outputs 19×19×256
First DVII 304×304×3.
First CONV layer of second part—receives 304×304×3 outputs 152×152×32
Second CONV layer of second part—receives 152×152×32 outputs 76×76×64
Third CONV layer of second part—receives 76×76×64 outputs 38×38×128
Fifth CONV layer of second part—receives 38×38×128 outputs 19×19×256
Second converter—receives 19×19×256 outputs 19×19×256
First feature combiner—receives two 19×19×256 inputs and outputs 19×19×512

FIG. 4 illustrates the second part 9012′(1,2) of first branch 9012′(1) as including alternating layer of sixth till last convolutional and pooling layers—such as sixth till last convolutional layers 91(1,11)-91(1,N) and sixth till last pooling layers 91(1,12)-91(1,N+1).

The output of the last pooling layer is the output of the second part 9012′(1,2) of first branch 9012′(1)—and is sent to first region unit 9014(1).

FIG. 4 also illustrates that the first part 9012′(2,1) of second branch 9012′(2) includes alternating convolution (preferably convolution and nonlinearity) and pooling (sampling) layers. For example—FIG. 4 illustrates first, second, third, fourth and fifth convolutional (CONV) layers 91(2,1), 91(2,3), 91(2,5), 91(2,7) and 91(2,9) as well as first, second, third and fourth pooling (POOL) layers 91(2,2), 91(2,4), 91(2,6) and 91(2,8).

The feature combiner, and the second part of the second branch are not shown for brevity of explanation.

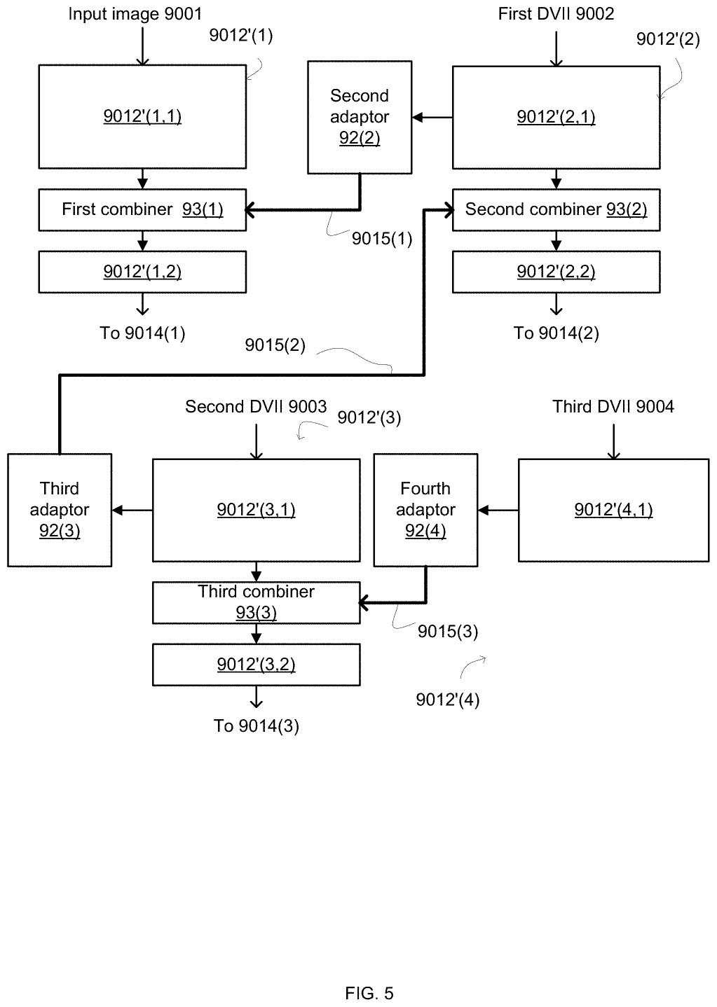

FIG. 5 illustrates three branches 9012′(1), 9012′(2), 9012′(3) and a first part and a fourth adaptor of a partial fourth branch 9012′(4).

The partial fourth branch does not generate any output to a fourth region unit and is provided for symmetry purpose—so that the output fed to the third region unit 90914(3) undergoes substantially the same process as the output provided to the first and second region units 9014(1) and 9014(2).

FIG. 4 illustrated first part 9012′(1,1) of first branch 9012′(1), first combiner 93(1), second part 9012′(1,2) of first branch 9012′(1), first part 9012′(2,1) of second branch 9012′(2) and second adaptor 92(2) of second branch 9012′(2).

FIG. 5 also illustrates second combiner 93(2), second part 9012′(2,2) of second branch 9012′ (2), first part 9012′ (3,1) of third branch 9012′ (3), third combiner 93(3), second part 9012′(3,2) of third branch 9012′(3), first part 9012′(4,1) of partial fourth branch 9012′(4) and fourth adaptor 92(4) of partial fourth branch 9012′(4).

Third adaptor 92(3) is configured to adapt intermediate results of first part 9012′(3,1) of third branch 9012′(3) before they are fed (over link 9015(2)) to second combiner 92(2).

Fourth adaptor 92(4) is configured to adapt intermediate results of first part 9012′(4,1) of fourth partial branch 9012′(4) before they are fed to third combiner 92(3).

The fourth partial branch 9012′(4) is fed by a third DVII 9004 which is coarser than second DVII 9003.

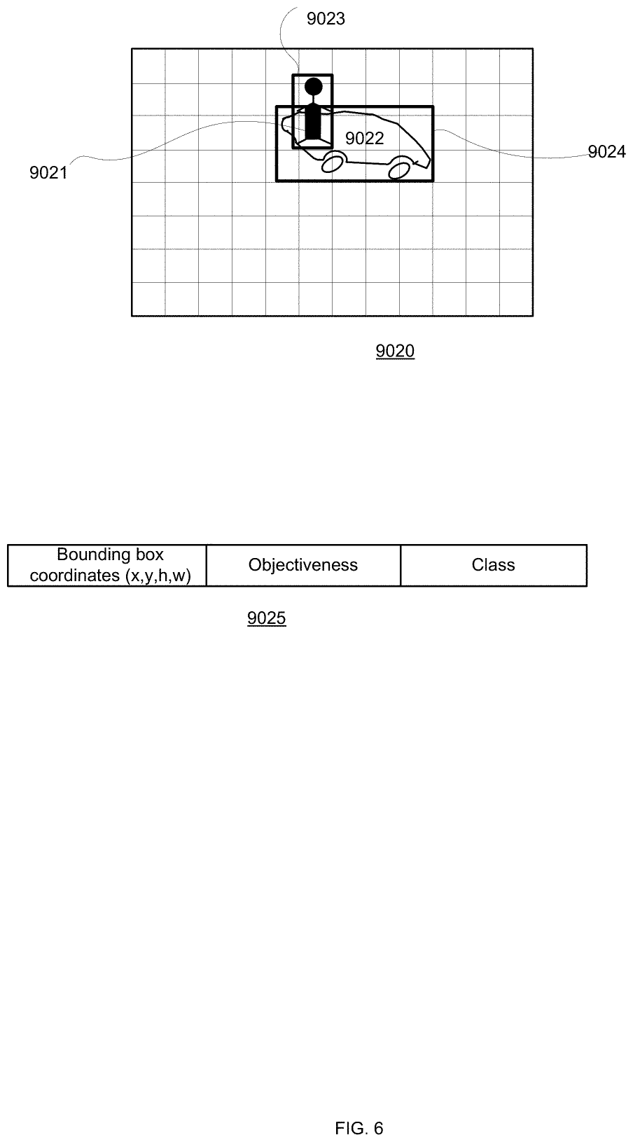

FIG. 6 illustrates an example of an image 9020, two objects—pedestrian 9021 and car 9022, two bounding boxes 9023 (bounding pedestrian 9021) and 9024 (bounding car 9022) and a bounding box output 9025.

The bounding box output 9025 may include coordinates (x,y,h,w) of the bounding boxes, objectiveness and class. The coordinate indicate the location (x,y) as well as the height and width of the bounding boxes. Objectiveness provides a confidence level that an object exists. Class—class of object—for example cat, dog, vehicle, person . . . ). The (x,y) coordinates may represent the center of the bounding box.

The object detection may be compliant to any flavor of YOLO—but other object detection schemes may be applied.

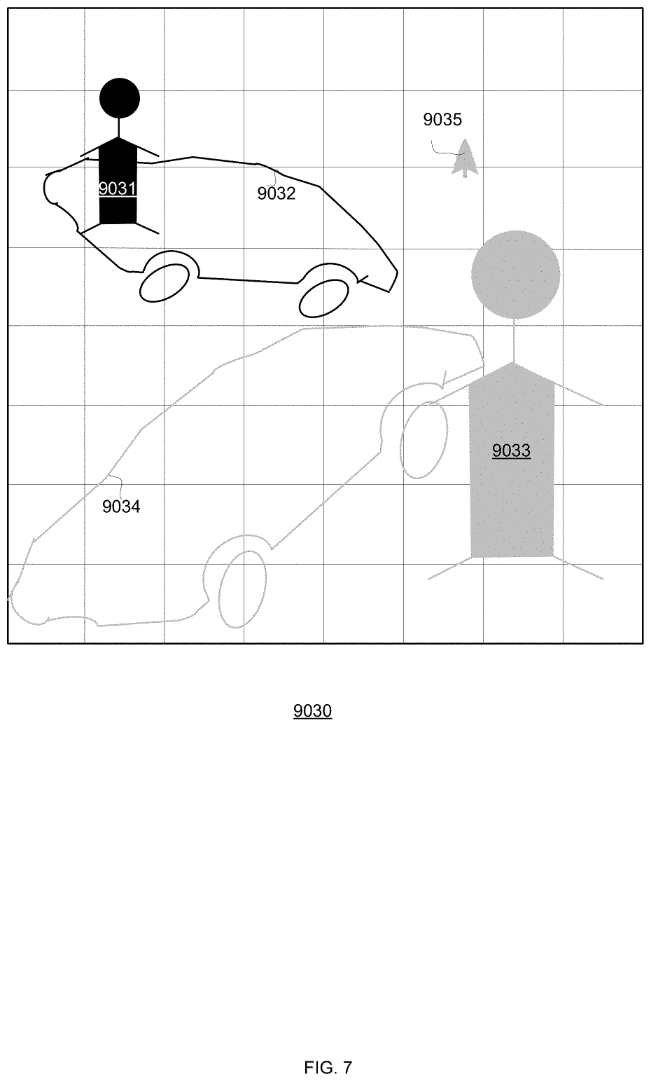

FIG. 7 illustrates an image 9030 and various objects 9031, 9032, 9033 and 9034.

Objects 9033 and 9034 are outside the predefined size range and should be ignored of. The single trained neural network is trained to detect objects 9031 and 9032 (within the predefined size range) and ignore objects 9033 and 9034.

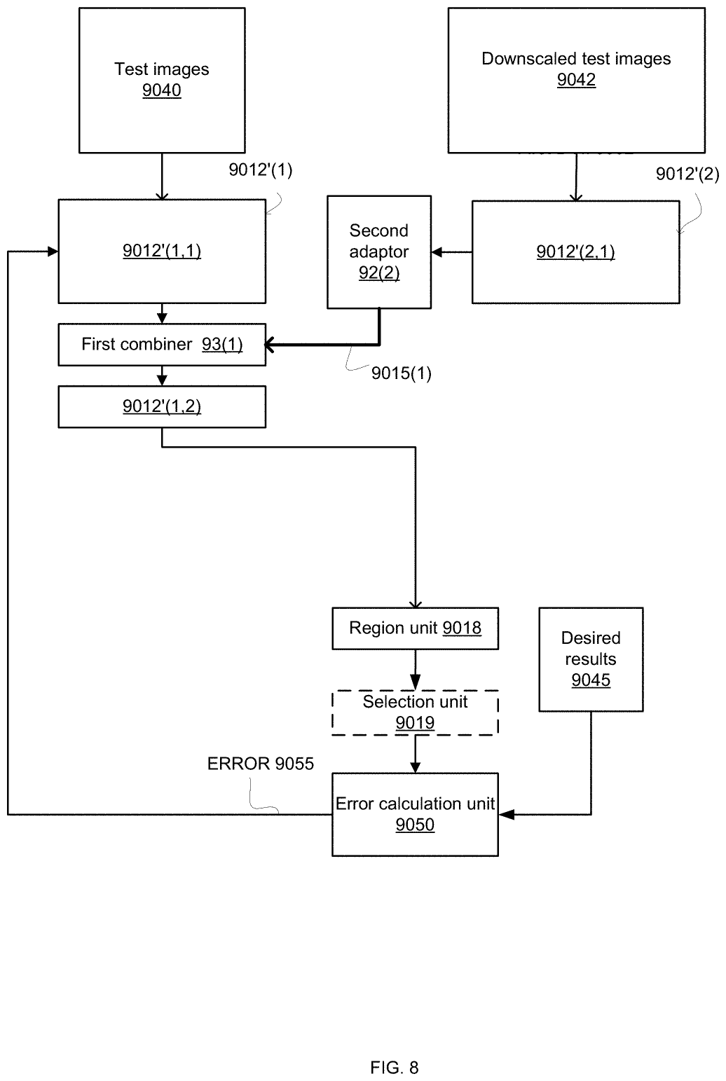

FIG. 8 illustrates an example of a training process.

Test images 9040 are fed to a first branch 9012′(1) and downscaled test images 9042 are fed to a partial second branch 9012′ that include a first part 9012′ (2,1) of the partial second branch 9012′(2) and second adaptor 92(2).

The configuration of the convolutional and pooling layers of the first part 9012′(1,1) of the first branch may be the same as those of the convolutional and pooling layers of the first part 9012′ (2,1) of the partial second branch 9012′(2).

The output of the first branch 9012′(1), for each test image, may be a tensor with multiple features per segment of the test image. The region unit 9018 is configured to receive the output from single shallow neural network 9017 and calculate and output candidate bounding boxes per test image. Actual results such as the output candidate bounding boxes per test image or an output of a selecting unit 9019 (that follows region unit 9018) may be fed to error calculation unit 9050.

Error calculation unit 9050 also receives desired results 9045—objects of a size of the predefined range that should be detected by the single shallow neural network 9017.

Error calculation unit 9050 calculates an error 9055 between the the actual results and the desired results- and the error is fed to the first branch 9012′(1) and to the partial second branch 9012′(2).

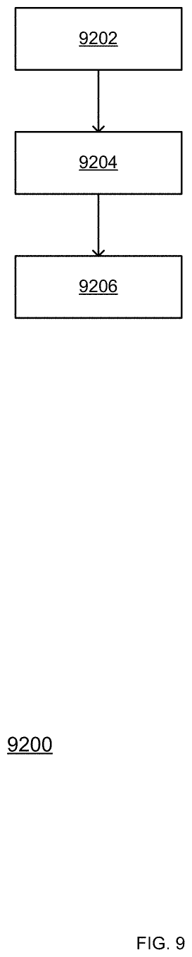

FIG. 9 illustrates an example of a method 9200 for object detection.

Method 9200 may include the following steps:
Step 9202 of receiving or generating multiple versions of an input image, wherein the multiple versions differ from each other by resolution.
Step 9204 of feeding the multiple versions of the input image to multiple branches of an object detector. The multiple branches may include multiple shallow neural networks that are followed by multiple region units. Each branch includes a shallow neural network and a region unit.
Step 9206 of calculating, by the multiple branches, candidate bounding boxes that are indicative of candidate objects that appear in the multiple versions of the input image. The calculating includes feeding intermediate results from shallow neural networks of lower resolution branches to shallow neural networks of higher resolution branches.
Step 9208 of selecting bounding boxes out of the candidate bounding boxes, by a selection unit that follows the multiple branches.

Step 9204 may include feeding by each source branch of at least some branches, a target branch that has a next higher resolution than the branch.

Step 9206 may include (i) receiving by each target branch, intermediate results from a source branch of a coarser resolution; (ii) combining the intermediate results within an output of an intermediate convolutional layer of the target branch to provide combined results; and (iii) processing the combined result by one or more additional layers of the target branch.

The combining may include concatenating.

Regarding step 9204—each source branch may include an adaptor for adapting an intermediate result of the shallow neural network of the source branch before feeding the intermediate result to a shallow neural network of the target branch.

The multiple shallow neural networks are multiple instances of a trained shallow neural network.

A shallow neural network of a target branch and a at least a first part of shallow neural network of a source branch that feeds the target branch may be trained to detect objects having a size that is within a predefined size range, and are trained to ignore objects having a size that is outside the predefined size range.

The predefined size range may range between (a) about ten by ten pixels, till (b) about one hundred by one hundred pixels.

Method 9200 may include performing the training.

Regarding step 9204—the intermediate results are provided from layers of a first part of the shallow neural network of the source branch. Layers of a first part of the shallow neural network of the target branch and layers of the first part of the shallow neural network of the source branch may have a same configuration.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Furthermore, the terms “assert” or “set” and “negate” (or “deassert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable sub-combination.

It will be appreciated by persons skilled in the art that the embodiments of the disclosure are not limited by what has been particularly shown and described hereinabove. Rather the scope of the embodiments of the disclosure is defined by the appended claims and equivalents thereof.

What is claimed is:

1. A method for object detection, the method comprises:
receiving or generating multiple versions of an input image, wherein the multiple versions differ from each other by resolution;
feeding the multiple versions of the input image to multiple branches of an object detector; wherein the multiple branches comprise multiple shallow neural networks that are followed by multiple region units; wherein each branch comprises a shallow neural network and a region unit;
calculating, by the multiple branches, candidate bounding boxes that are indicative of candidate objects that appear in the multiple versions of the input image; wherein the calculating comprises feeding intermediate results from shallow neural networks of lower resolution branches to shallow neural networks of higher resolution branches; and
selecting bounding boxes out of the candidate bounding boxes, by a selection unit that follows the multiple branches.

2. The method according to claim 1 wherein the feeding of the intermediate results comprises feeding by each source branch of at least some branches, a target branch that has a next higher resolution than the branch.

3. The method according to claim 2 comprising:
receiving by each target branch, intermediate results from a source branch of a coarser resolution;
combining the intermediate results within an output of an intermediate convolutional layer of the target branch to provide combined results; and
processing the combined result by one or more additional layers of the target branch.

4. The method according to claim 3 wherein the combining comprises concatenating.

5. The method according to claim 3 wherein each source branch comprises an adaptor for adapting an intermediate result of the shallow neural network of the source branch before feeding the intermediate result to a shallow neural network of the target branch.

6. The method according to claim 1 wherein the multiple shallow neural networks are multiple instances of a trained shallow neural network.

7. The method according to claim 6 wherein a shallow neural network of a target branch and a shallow neural network of a source branch that feeds the target branch are trained to detect objects having a size that is within a predefined size range, and are trained to ignore objects having a size that is outside the predefined size range.

8. The method according to claim 7 wherein the intermediate results are provided from layers of a first part of the shallow neural network of the source branch; and wherein layers of a first part of the shallow neural network of the target branch and layers of the first part of the shallow neural network of the source branch have a same configuration.

9. The method according to claim 7 wherein the predefined size range ranges between (a) about ten by ten pixels, till (b) about one hundred by one hundred pixels.

10. The method according to claim 6 comprising training a shallow neural network of a target branch and a shallow neural network of a source branch that feeds the target branch to detect objects having a size that is within a predefined size range, and are trained to ignore objects having a size that is outside the predefined size range.

11. A non-transitory computer readable medium for detecting an object by an object detector, wherein the non-transitory computer readable medium stores instructions for:
receiving or generating multiple versions of an input image, wherein the multiple versions differ from each other by resolution;
feeding the multiple versions of the input image to multiple branches of an object detector; wherein the multiple branches comprise multiple shallow neural networks that are followed by multiple region units; wherein each branch comprises a shallow neural network and a region unit;
calculating, by the multiple branches, candidate bounding boxes that are indicative of candidate objects that appear in the multiple versions of the input image;
wherein the calculating comprises feeding intermediate results from shallow neural networks of lower resolution branches to shallow neural networks of higher resolution branches; and
selecting bounding boxes out of the candidate bounding boxes, by a selection unit that follows the multiple branches.

12. The non-transitory computer readable medium according to claim 11 wherein the feeding of the intermediate results comprises feeding by each source branch of at least some branches, a target branch that has a next higher resolution than the branch.

13. The non-transitory computer readable medium according to claim 12 that stores instructions for:
receiving by each target branch, intermediate results from a source branch of a coarser resolution;
combining the intermediate results within an output of an intermediate convolutional layer of the target branch to provide combined results; and
processing the combined result by one or more additional layers of the target branch.

14. The non-transitory computer readable medium according to claim 13 wherein the combining comprises concatenating.

15. The non-transitory computer readable medium according to claim 13 wherein each source branch comprises an adaptor for adapting an intermediate result of the shallow neural network of the source branch before feeding the intermediate result to a shallow neural network of the target branch.

16. The non-transitory computer readable medium according to claim 11 wherein the multiple shallow neural networks are multiple instances of a trained shallow neural network.

17. The non-transitory computer readable medium according to claim 16 wherein a shallow neural network of a target branch and a shallow neural network of a source branch that feeds the target branch are trained to detect objects having a size that is within a predefined size range, and are trained to ignore objects having a size that is outside the predefined size range.

18. The non-transitory computer readable medium according to claim 17 wherein the intermediate results are provided from layers of a first part of the shallow neural network of the source branch; and wherein layers of a first part of the shallow neural network of the target branch and layers of the first part of the shallow neural network of the source branch have a same configuration.

19. The non-transitory computer readable medium according to claim 17 wherein the predefined size range ranges between (a) about ten by ten pixels, till (b) about one hundred by one hundred pixels.

20. The non-transitory computer readable medium according to claim 16 that stores instructions for training a shallow neural network of a target branch and a shallow neural network of a source branch that feeds the target branch to detect objects having a size that is within a predefined size range, and are trained to ignore objects having a size that is outside the predefined size range.

21. An object detector that comprises an input unit, multiple branches, and a selection unit;
wherein the input unit is configured to receive or generate multiple versions of an input image, wherein the multiple versions differ from each other by resolution;
wherein the multiple branches of the object detector are configured to:
(i) receive the multiple versions of the input image to multiple branches of an object detector; wherein the multiple branches comprise multiple shallow neural networks that are followed by multiple region units; wherein each branch comprises a shallow neural network and a region unit;
(ii) calculate candidate bounding boxes that are indicative of candidate objects that appear in the multiple versions of the input image; wherein the calculating comprises feeding intermediate results from shallow neural networks of lower resolution branches to shallow neural networks of higher resolution branches; and
wherein the selection unit is configured to select bounding boxes out of the candidate bounding boxes, by a selection unit that follows the multiple branches.

22. The object detector according to claim 21 wherein each source branch of at least some branches, is configured to feed with intermediate results, a target branch that has a next higher resolution than the branch.

23. The object detector according to claim 22 wherein each target branch comprises an combiner that is configured to combine the intermediate results with an output of an intermediate convolutional layer of the target branch to provide combined results; and wherein a shallow neural network of the target branch comprises one or more additional layers that the configured to process the combined result.

24. The object detector according to claim 23 wherein the combiner is configured to concatenate the intermediate results with the output of the intermediate convolutional layer of the target branch.

25. The object detector according to claim 23 wherein each source branch comprises an adaptor for adapting an intermediate result of the shallow neural network of the source branch before feeding the intermediate result to a shallow neural network of the target branch.

26. The object detector according to claim 21 wherein the multiple shallow neural networks are multiple instances of a trained shallow neural network.

27. The object detector according to claim 26 wherein a shallow neural network of a target branch and a shallow neural network of a source branch that feeds the target branch are trained to detect objects having a size that is within a predefined size range, and are trained to ignore objects having a size that is outside the predefined size range.

28. The object detector according to claim 27 wherein the intermediate results are provided from layers of a first part of the shallow neural network of the source branch; and wherein layers of a first part of the shallow neural network of the target branch and layers of the first part of the shallow neural network of the source branch have a same configuration.

29. The object detector according to claim 27 wherein the predefined size range ranges between (a) about ten by ten pixels, till (b) about one hundred by one hundred pixels.
